(19) United States
(12) Patent Application Publication
(10) Pub. No.: US 2007/0198173 A1
(43) Pub. Date: Aug. 23, 2007

(54) Return route search device, circuit design apparatus and circuit design program storage medium

(75) Inventors: Yasuhiro Yamashita, Kawasaki (JP); Hidenobu Shiihara, Kawasaki (JP); Ryouji Yamada, Kawasaki (JP); Mitunobu Okano, Kawasaki (JP); Takashi Fukuda, Oyama (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/507,526

(22) Filed: Aug. 22, 2006

(30) Foreign Application Priority Data
Feb. 23, 2006 (JP) 2006-047318

(51) Int. Cl. G01C 21/00

(52) U.S. Cl. 701/201; 701/210; 340/995.23

(57) ABSTRACT

A return route search device includes a starting point/destination point setting section which accepts the setting of a starting point on a circuit from which a return current starts accompanied by a signal transmission on the circuit, and a setting of a destination point on the circuit to which the current flows. The return route search device further includes an easiness setting section which accepts a setting of easiness of conduction of the return current through each of portions on the circuit, and a return route search section which searches for a route when the return current flows from the starting point to the destination point on the basis of the easiness of conduction on the circuit.

### BACKGROUND OF THE INVENTION

1. Field of the Invention

The invention relates to a return route search device having a function to search for a route (return current path) for a return current generated accompanied by a signal transmission on a circuit. The invention also relates to a circuit design apparatus and a circuit design program storage medium.

2. Description of the Related Art

Circuit design apparatuses typified by computer-aided design (CAD) apparatuses having an automatic wiring function have come into wide use for designing wiring for a signal transmission routes in large scale integrated circuits (LSIs) and printed circuit boards. The automatic wiring function is performed to automatically search for routes having no intersection and no overlap. A user of the circuit design apparatus can design a circuit with efficiency by using the routes thereby found.

It is known that when a signal transmission is performed in an LSI or a printed circuit board, a return current is generated accompanied by the signal transmission, and that noise radio waves or the like are emitted if the route for the return current is an unsuitable route separating much from the signal transmission route. Therefore, a current distribution on a circuit designed by using the circuit design apparatus is analyzed by using an electromagnetic field analysis tool on the circuit to check the flow of return current. If the route for the return current is unsuitable, a designer changes the design of the circuit.

A technique to prohibit wiring including a detour around a slit or other patterns formed in a ground (GND) pattern or a power supply pattern in order to secure a region right below the signal transmission route as a return current route has been proposed (see, for example, Japanese Patent Laid-Open No. 11-3167-7-4 and Japanese Patent Laid-Open No. 2004-252743). A technique to determine a search region within a certain width from a signal transmission route and to obtain the shortest path along the signal transmission route within the search region as a return current route has also been proposed (see, for example, Japanese Patent Laid-Open No. 2003-196340).

The technique to analyze a current distribution on a circuit by using an electromagnetic field analysis tool ensures that a correct return current route can be obtained with accuracy, but entails a problem that the time required to make a model or execute analysis is considerably long.

If the technique disclosed in Japanese Patent Laid-Open No. 11-316774 or the technique disclosed in Japanese Patent Laid-Open No. 2004-252743 is implemented, unsuitable return current routes are precluded. However, the strict method of securing the region right below the signal transmission route under any condition considerably entails a problem that it reduces the freedom of designing to make it difficult to obtain a suitable design.

The technique disclosed in Japanese Patent Laid-Open No. 2003-196340 entails a problem that method of obtaining a search region and a return current route is too simple to obtain a correct route.

### SUMMARY OF THE INVENTION

The invention has been made in view of the above circumstances and provides a return route search device capable of obtaining a return current route in a short time with accuracy, and a circuit design apparatus having such a return route search function.

The invention provides a return route search device. The return route search device includes a starting point/destination point setting section that accepts a setting of a starting point on a circuit from which a return current starts accompanied by a signal transmission on the circuit, and a setting of a destination point on the circuit which the return current reaches, an easiness setting section that accepts a setting of easiness of conduction of the return current through each of portions on the circuit; and a return route search section that searches for a route when the return current flows from the starting point to the destination point on the basis of the easiness of conduction on the circuit.

If electromagnetic field analysis is performed to obtain a return current, a current distribution can be obtained with accuracy. At the time of determination as to the quality of a circuit design made by examining the propriety of a return current, however, there is no need for such a current distribution and it is possible to determine the quality of the circuit design only by knowing a route through which the largest amount of current flows.

In the return route search device of the invention, a search for a route is made on the basis of a degree of easiness of conduction of a return current set in the easiness setting section. Therefore, execution of unnecessary analysis can be avoided and a correct route can be obtained in a short time. Such a search is realized through an application of a search technique used for an automatic wiring function in a circuit design apparatus. By checking a route found by such a search, a designer can make determination as to propriety of the return current route and determination as to the quality of the circuit design, and can take steps, for example, to add a capacitor or a power supply VIA with respect to an unsuitable return current route. The short-time accurate search for a return current route made by the return route search device of the invention is also effective in checking the effect of steps taken with respect to an unsuitable return current route.

It is preferable that the return route search device of the invention has a display section which displays the route obtained by the return route search section.

The return route search device having such a display section enables a designer to make determination as to propriety of a route by visually checking the route through the display section.

It is preferable that the return route search device of the invention includes a transmission route identification section that accepts identification of a route of the signal transmission on the circuit, and a setting reflection section that sets the starting point and the destination point in the starting point/destination point setting section on the basis of the route identified in the transmission route identification section and a predetermined setting rule, and that sets the easiness of conduction in the easiness setting section.

“Identification of a signal transmission route” accepted by the transmission route identification section refers to selection of a conductor pattern through which signal transmission is performed on a circuit, designation of a signal transmission starting point, a via point and a destination point on the circuit, and the like.

In the return route search device having the setting reflection section, a return current route is searched for by automatically reflecting a signal transmission route in a starting point and easiness of conduction with respect to a return current. The return route search device can therefore be operated, for example to automatically search for a return current route with respect to each of signal transmission routes on a circuit designed by a CAD apparatus or the like.

It is preferable that the return route search device of the invention further includes a transmission route identification section that accepts identification of a route of the signal transmission on the circuit, and a first good-bad determination section that computes the area surrounded by a loop going through both the route identified in the transmission route identification section and the route obtained by the return route search section, and that determines whether or not the return current route is good on the basis of the area.

Further, it is preferable that the return route search device of the invention includes a transmission route identification section that accepts identification of a route of the signal transmission on the circuit and a second good-bad determination section that computes the difference between the length of the route identified in the transmission route identification section and the length of the route obtained by the return route search section, and that determines whether or not the return current route is good on the basis of the difference.

If the signal transmission route and the return current route are distanced from each other so that the loop formed by the two routes is increased in size, the stability of signal transmission is reduced and radiated noise radio waves are increased. As an index indicating the size of such a loop, the area surrounded by the loop and the difference between the lengths of the two routes can be adopted. In the good/no-good determination section, determination as to whether or not the return current route is good is automatically made on the basis of the values of these indices. The return route search device having the good/no-good determination section ensures that the load on a circuit designer in making determination as to the quality of the circuit design can be reduced.

In the return route search device of the invention, it is preferable that the starting point/destination point setting section accepts the setting of a starting point and the setting of a destination point with respect to each of a plurality of return currents generated with each of a plurality of signal transmissions, the easiness setting section accepts the setting of easiness of conduction in correspondence with each of the plurality of signal transmissions, and the return route search section searches for a plurality of routes corresponding to each of the plurality of return currents, and the return route search device further includes a concentration position search section that obtains a position at which the plurality of routes are concentrated on the circuit.

On an LSI or a printed circuit board, a net through which a multiplicity of signals are transmitted is formed, and a multiplicity of return currents are generated in correspondence with transmission of the multiplicity of signals performed on the net. If a number of return current routes are thereby concentrated on one portion on the net, currents are concentrated to cause an increase in noise.

The return route search device having the concentration position search section ensures that a position at which routes are concentrated as described above can be identified to enable the designer to check a portion acting as a cause of an increase in noise and to suitably and easily take steps, for example, to add a capacitor or a power supply VIA.

The invention also provides a circuit design apparatus. The circuit design apparatus includes a design section that designs a circuit in accordance with an operation, a starting point/destination point setting section that accepts a setting of a starting point on the circuit designed in the design section, from the starting point starting a return current generated with a signal transmission on the circuit, and a setting of a destination point on the circuit which the return current reaches, an easiness setting section that accepts a setting of easiness of conduction of the return current through each of portions on the circuit designed in the design section, and a return route search section that searches for a route when the return current flows from the starting point to the destination point on the basis of the easiness of conduction on the circuit.

The circuit design apparatus of the invention is capable of accurately searching for a return current route on a circuit designed in the design section in a short time. The circuit design apparatus thereby enables the designer to easily determine whether or not the designed circuit is good.

The invention further provides a circuit design program storage medium storing a circuit design program. The circuit design program is incorporated in a computer and constructs on the computer a design section that designs a circuit in accordance with an operation, a starting point/destination point setting section that accepts a setting of a starting point on the circuit designed in the design section, from the starting point starting a return current generated with a signal transmission on the circuit, and a setting of a destination point on the circuit which the return current reaches, an easiness setting section that accepts a setting of easiness of conduction of the return current through each of portions on the circuit designed in the design section, and a return route search section that searches for a route when the return current flows from the starting point to the destination point on the basis of the easiness of conduction on the circuit.

The circuit design program of the invention ensures that components for realizing the circuit design apparatus having the return route search function for easily and correctly obtaining a return current route can be easily constructed on a computer.

Only the basic forms of the circuit design apparatus and the circuit design program storage medium in accordance with the invention are described here. This simplification of description is only for avoiding redundancy. The circuit design apparatus and so on of the invention include various forms corresponding to the above-described forms of the return route search device as well as the basic forms.

The components including the easiness setting section constructed on a computer by the circuit design program in accordance with the invention may be such that one component is formed by one program part; one component is formed by program parts; or components are formed by one program part. These components may be constructed so as to perform the corresponding functions by themselves or execute the functions by providing instructions to a different program or program parts incorporated in the computer.

According to the invention, as described above, a return route search device capable of obtaining a return current route in a short time with accuracy and a circuit design apparatus having the functions for such return route searching can be obtained.

### BRIEF DESCRIPTION OF THE DRAWINGS

FIG. 1 is a perspective view of an external appearance of a computer to which an embodiment of the invention is applied;

FIG. 2 is a diagram showing a hardware configuration of the computer shown in FIG. 1;

FIG. 3 is a diagram showing a CD-ROM on which a CAD program corresponding to an embodiment of the circuit design program storage medium of the invention is stored;

FIG. 4 is a functional block diagram of a CAD apparatus corresponding to an embodiment of the circuit design apparatus of the invention;

FIG. 5 is schematic diagram showing signal transmission and a return current on a circuit;

FIG. 6 is a flowchart showing an operation of a return route search function section;

FIG. 7 is a schematic diagram showing parameter values set at each of portions on the circuit;

FIG. 8 is a schematic diagram showing the area of a loop;

FIG. 9 is a schematic diagram showing the relationship between the loop size and the difference between the route lengths; and

FIG. 10 is a diagram showing an example of a display produced by a display section.

### DETAILED DESCRIPTION OF THE INVENTION

An exemplary embodiment of the invention will be described with reference to the accompanying drawings.

An example of a configuration of a CAD apparatus corresponding to an embodiment of the circuit design apparatus of the invention will be described. The CAD apparatus is configured on a computer by loading and executing on the computer a CAD program corresponding to an embodiment of the circuit design program of the invention.

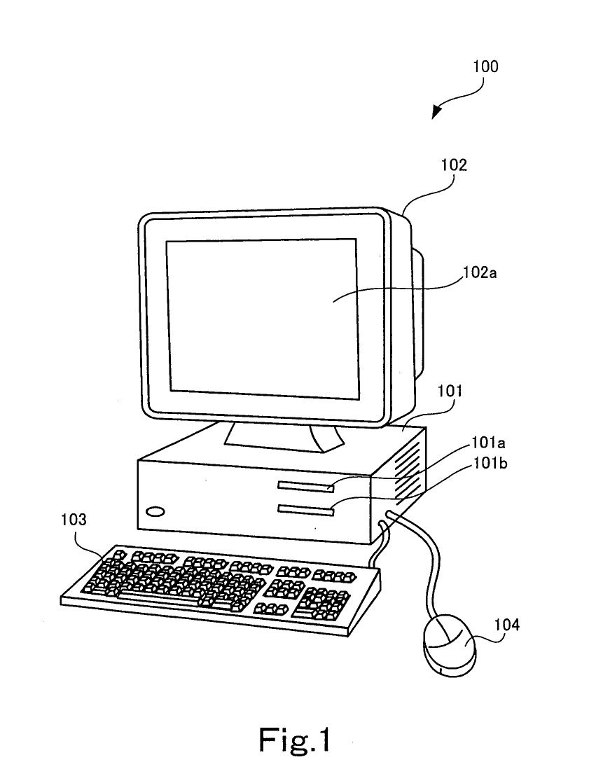

FIG. 1 is a perspective view of an external appearance of a computer to which an embodiment of the invention is applied.

This computer 100 is provided with a main unit 101 incorporating a CPU, a RAM, a hard disk, etc., a CRT display 102 which produces an on-screen display on a fluorescent surface 102a in response to a command from the main unit 101, a keyboard 103 for inputting a user command or character information to the computer, and a mouse 104 for designating an arbitrary position on the fluorescent surface 102a to input a command corresponding to the position.

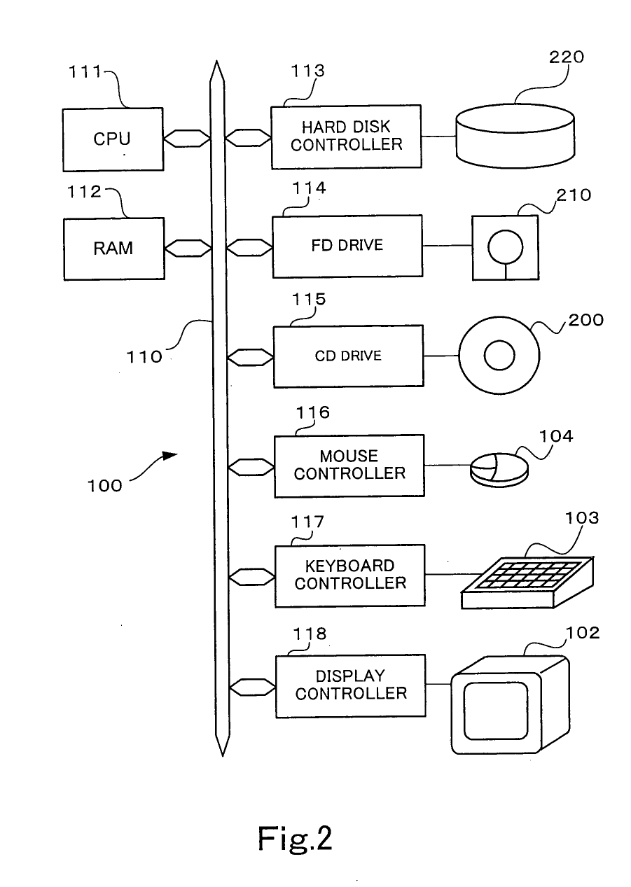

The main unit 101 further has, as its components seen its appearance: a flexible disk loading port 101a through which a flexible disk 210 (not shown in FIG. 1; see FIG. 2) is loaded, and a CD loading port 101b through which each of various CDs such as a CD-ROM 200 (see FIG. 2), a CD-R and CD-RW is loaded. Inside these ports are mounted a flexible disk drive 114 and a CD drive 115 (see FIG. 2) which respectively drive a flexible disk and a CD loaded therein.

In this embodiment, the CAD program is stored on the CD-ROM. The CD-ROM is loaded in the main unit 101 through the CD loading port 101b, and the Cad program stored in the CD-ROM is installed on the hard disk of the computer 100 by the CD drive. When the CAD program installed on the hard disk of the computer 100 is started up, the CAD apparatus corresponding to an embodiment of the circuit design apparatus of the invention is configured on the computer 100.

FIG. 2 is a diagram showing the hardware configuration of the computer shown in FIG. 1.

As shown in FIG. 2, the computer 100 is provided with a central processing unit (CPU) 111, a RAM 112, a hard disk controller 113, the flexible disk drive 114, the CD drive 115, a mouse controller 116, a keyboard controller 117 and a display controller 118. These components are connected to each other through a bus 110.

In the flexible disk drive 114 and the CD drive 115, the flexible disk 210 and the CD-ROM 200 are respectively loaded, as described above with reference to FIG. 1, and the loaded flexible disk 210 and the CD-ROM 200 are accessed.

In FIG. 2 are also illustrated a hard disk 220 accessed by the hard disk controller 113, the mouse 104 controlled by the mouse controller 116, the keyboard 103 controlled by the keyboard controller 117, and the CRT display 102 controlled by the display controller 118.

As described above, the CAD program is stored on the CD-ROM 200, and the CAD program is read from the CD-ROM 200 by the CD drive 115 and is stored in the hard disk 220 by the hard disk controller 113 via the bus 110. At the time of actual execution of the CAD program, the CAD program in the hard disk 220 is loaded on the RAM 112 and executed by the CPU 111.

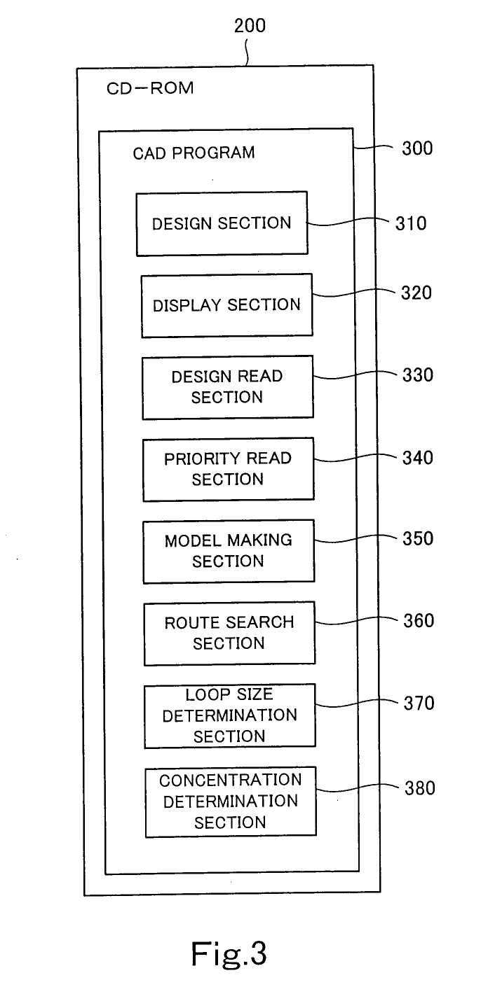

FIG. 3 is a diagram showing a CD-ROM storing a CAD program, corresponding to an embodiment of the circuit design program storage medium of the invention. A CAD program 300 is stored on the CD-ROM 200 in this case.

This CAD program 300 has as its components a design section 310, a display section 320, a design read section 330, a priority read section 340, a model forming section 350, a route search section 360, a loop size determination section 370, and a concentration determination section 380. Of these components, the design read section 330, the priority read section 340, the model forming section 350, the route search section 360, the loop size determination section 370 and the concentration determination section 380 constitute an embodiment of the return route search program in accordance with the invention. When the CAD program 300 is executed in the computer 100 shown in FIG. 1, the computer 100 operates as the CAD apparatus incorporating the functions as an embodiment of the return route search device of the invention. The CAD apparatus corresponds to an embodiment of the circuit design apparatus of the invention.

The storage medium in which the circuit design program and the return route search program of the invention are stored may be any of various kinds of storage mediums capable of storing programs. For example, the storage medium may be a magnetic disk in a hard disk unit, a flexible disk, an MO disk, a DVD, or a card-type or a tape-type storage medium.

Details of the components of the CAD program 300 shown in FIG. 3 will be described later.

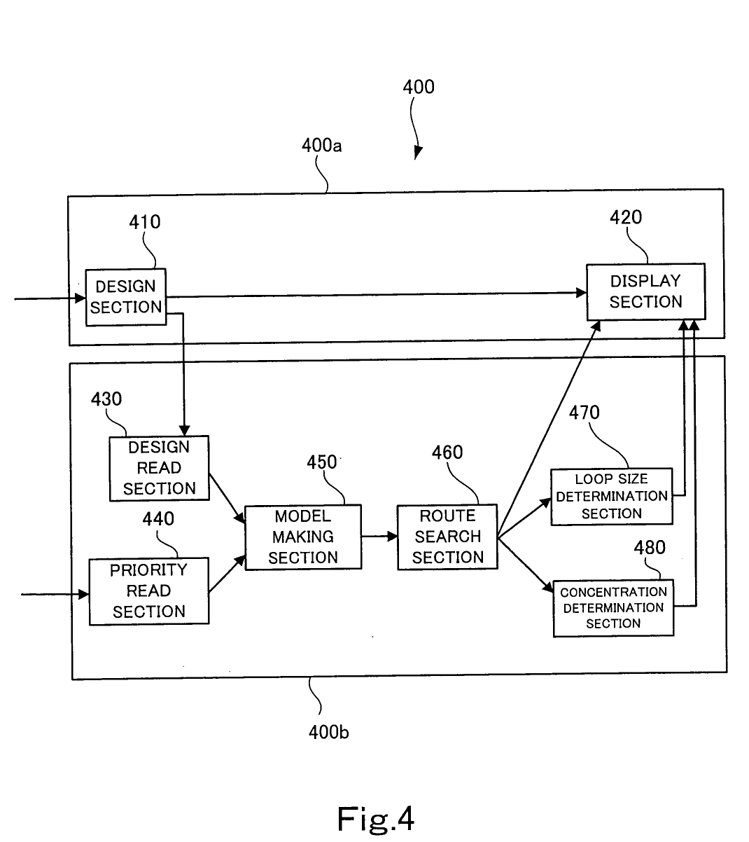

FIG. 4 is a functional block diagram of a CAD apparatus corresponding to an embodiment of the circuit design apparatus of the invention.

This CAD apparatus 400 is configured through installing and executing on the computer 100 shown in FIG. 1, the CAD program 300 shown in FIG. 3.

This CAD apparatus 400 has as its components a design section 410, a display section 420, a design read section 430, a priority read section 440, a model making section 450, a route search section 460, a loop size determination section 470, and a concentration determination section 480. The design section 410 and the display section 420 constitute a circuit design function section 400a. The design read section 430, the priority read section 440, the model making section 450, the route search section 460, the loop size determination section 470 and the concentration determination section 480 constitute a return route search function section 400b.

Each of the components of the CAD apparatus 400 is configured on the computer by each of the components of the CAD program 300 shown in FIG. 3. The components of the CAD apparatus 400 shown in FIG. 4 correspond respectively to the components of the CAD program 300 shown in FIG. 3. However, the components of the CAD apparatus shown in FIG. 4 differ from the components shown in FIG. 3 in that the components shown in FIG. 4 are constituted by a combination of the hardware of the computer 100 shown in FIG. 1 and an OS or an application program executed on the personal computer, while the components shown in FIG. 3 are constituted only by the application program in the combination of the hardware and the OS or the application program.

Of the components constituting the CAD apparatus, the design section 410 corresponds to an example of the design section in accordance with the invention; the display section 420 corresponds to an example of the display section in accordance with the invention; and the design read section 430 corresponds to an example of the transmission route identification section in accordance with the invention. The priority read section 440 reads a “predetermined setting rule” in accordance with the invention. The model making section 450 corresponds to an example of a section capable of functioning as each of the starting point/destination point setting section, the easiness setting section and the setting reflection section in accordance with the invention. The route search section 460 corresponds to an example of the return route search section in accordance with the invention. The loop size determination section 470 corresponds to an example of a section capable of functioning as each of the first good/no-good determination section and the second good/no-good determination section in accordance with the invention. The concentration determination section 480 corresponds to an example of the concentration position search section in accordance with the invention. Accordingly, the return route search function section 400b corresponds to an exemplary embodiment of the return route search device of the invention. The display section 420 for the circuit design function section 400a also functions as a component of the return route search device of the invention.

Description will be made below of the components of the CAD apparatus 400 shown in FIG. 4 as well as of the components of the CAD program 300 shown in FIG. 3. In some portion of the following description, a reference is made to the components shown in FIG. 4 without referring to the figure number.

In the design section 410 constituting the circuit design function section 400a of the CAD apparatus 400, a circuit is designed according to operations through the keyboard 103 and the mouse 104 shown in FIG. 1. The display section 420 displays the designed circuit on the CRT display 102 shown in FIG. 1. The circuit design function section 400a constituted by the design section 410 and the display section 420 is a section which performs well-known functions in the functions of the CAD apparatus.

In a circuit designed by the circuit design function section 400a a signal is transmitted and a return current is generated on the circuit accompanied by the signal transmission.

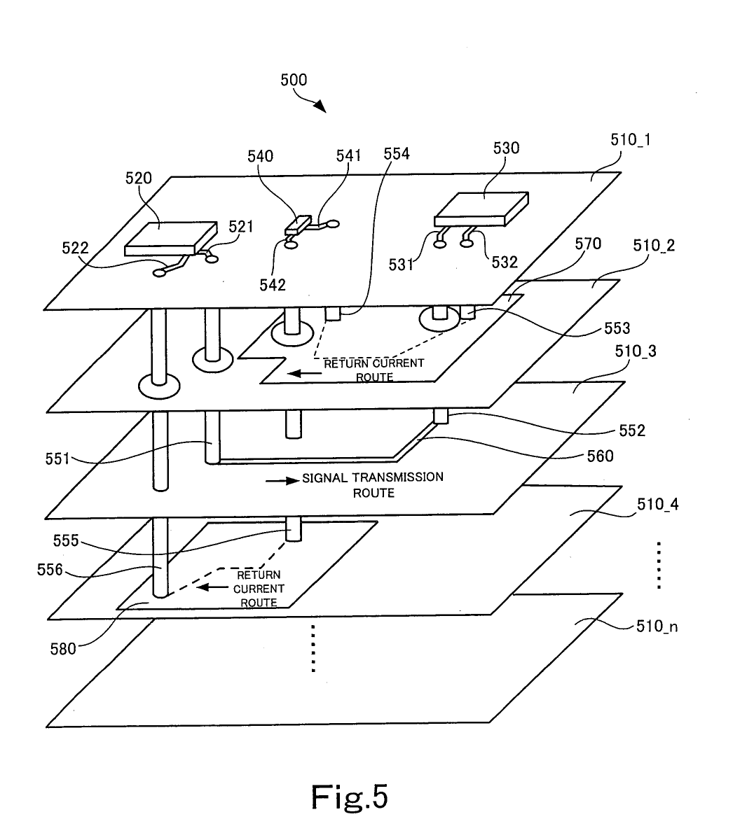

FIG. 5 is a schematic diagram showing signal transmission and a return current on a circuit.

In FIG. 5, a printed circuit board 500 is shown as an example of a circuit designed in the above-described circuit design function section. The printed circuit board 500 is a multilayer board constituted by n number of layers 510_1, 510_2, 510_3, 510_4, . . . , 510_{—}n. The first layer 510_1 and the third layer 510_3 are signal layers on which signal wiring patterns are laid out. The second layer 510_2 is a power supply layer on which a power supply pattern is laid out. The fourth layer 510_4 is a GND layer on which a GND pattern is laid out. Two ICs 520 and 530 and one capacitor 540 are disposed as circuit elements on the first layer 510_1. A route of signal transmission performed on this circuit is a transmission route in which, for example, a signal output from a signal pin (output pin) 521 of the first IC 520 reaches the third layer 510_3 through a VIA 551, travels through a signal wiring pattern 560 in the third layer 510_3, and reaches a signal pin (input pin) 531 of the second IC 530 through another VIA 552.

A return current accompanied by a signal transmission ordinarily passes through components constituting a power supply GND net, including a power supply pattern, a GND pattern, a capacitor, a VIA and power supply wiring. For example, if signal transmission through the transmission route shown in FIG. 5 is executed on the circuit, a return current accompanied by the signal transmission is generated to flow from a power supply pin 532 of the second IC 530 and reach a GND pin 522 of the first IC 520. The route for this return current starting from the power supply pin 532 of the second IC 530 extends to a point on the second layer (power supply layer) 510_2 through a VIA 553, extends through a power supply pattern 570 laid on the second layer 510_2, as indicated by the dotted line in FIG. 5, to enter a power supply pin 541 of the capacitor 540 through a VIA 554, extends from a GND pin 542 of the capacitor 540 to a point on the fourth layer (GND layer) 510_4 through a VIA 555, extends through a GND pattern 580 laid on the fourth layer 510_4, as indicated by the dotted line in FIG. 5, and reaches the GND pin 522 of the first IC 520 through a VIA 556.

Propriety of such a return current route largely influences the quality of a circuit design. It is, therefore, necessary for a designer to check appropriately a route for return current in designing a circuit. To enable a designer to do so, the return route search function section 400b capable of easily and accurately search return current routes is provided in the CAD apparatus 400.

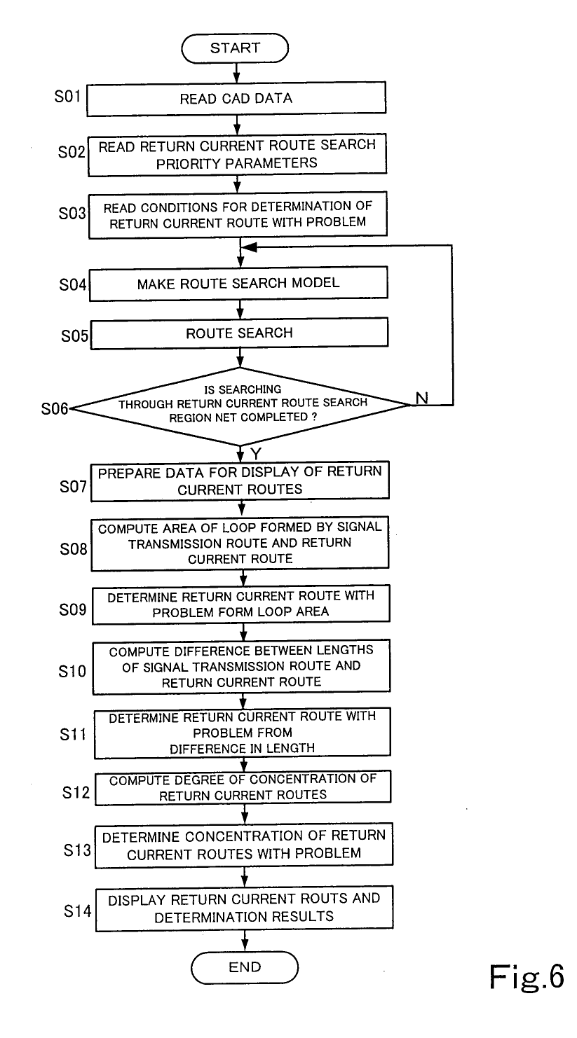

FIG. 6 is a flowchart showing an operation of a return route search function section.

The operations of the components of the return route search function section 400b will be described with reference to this flowchart.

The return route search function section 400b starts operating when a circuit is designed in the circuit design function section 400a. The design read section 430 first reads CAD data of the circuit designed in the design section 410 of the circuit design function section 400a (step S01). The design section 410 incorporates the function of checking routes of signal transmission performed on a designed circuit. When the design read section 430 reads the CAD data of the circuit, the design section ascertains the routes of the signal transmissions performed on the circuit, and the design section 430 also takes in data on the transmission routes.

The priority read section 440 then reads from the hard disk priority parameters each representing a degree of easiness of conduction of a return current (step S02). The priority parameters are derived from digitized proprieties in searching for return current routes in a route search described below. For example, a priority assigned to a GND layer or a power supply layer closer to a signal wiring conductor through which a signal is transmitted is higher than a priority assigned to a remoter GND or power supply layer. In a GND pattern or a power supply pattern, a portion right above or below a signal wiring conductor is assigned a priority higher than those assigned to other portions. A VIA of a larger diameter is assigned a higher priority. A thicker power supply layer or a thicker GND layer is assigned to a higher priority. A capacitor of a higher capacitance is assigned a higher priority. The above-described priorities include those absolutely determined with respect to positions on the circuit indicated by the CAD data, and also those relatively determined only after determination of signal transmission routes to be searched in a return current route search. That is, the priority parameters read by the priority read section 440 represent a rule of easiness of conduction of return currents, and do not represent concrete degrees of easiness of conduction through portions on the circuit. The priority read section 440 also reads determination conditions used at the time of determination as to propriety of a return current route (step S03).

After the design read section 430 and the priority read section 440 read the CAD data and priority parameters and etc., the model making section 450 makes a return current route search model by setting return current starting and destination points on the circuit and assigning priority parameters to portions on the circuit (step S04). This search model is made with respect to each of signal transmission routes. The model making section 450 sets, as a return current route starting and destination points, a power supply pin or a GND pin closest to a starting pin and a destination pin, respectively, in each signal transmission route. There is a possibility of failure to correctly make this setting. In addition, the model making section 450 also incorporates a function to enable the designer to change staring and destination points by operating the keyboard 103 or the mouse 104. The model making section 450 also sets concrete parameter values at each of portions on the circuit on the basis of the priority parameter rule described above and the concrete signal transmission route. In this setting, the higher the priority, the smaller the assigned parameter value.

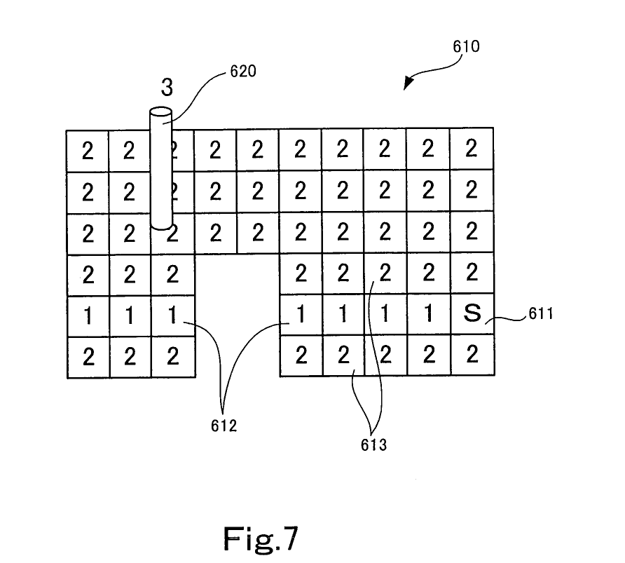

FIG. 7 is a schematic diagram showing parameter values set at each of portions of the circuit.

In FIG. 7, a GND pattern 610 and a VIA 620 are shown as portions of the circuit. A starting point 611 on the GND pattern 610 is directly connected to a return current starting point. Each of portions 612 right above or below a signal transmission route is assigned a priority “1”. Each of portions 613 other than the portions 612 is assigned a priority “2”. A VIA 620 is assigned a priority “3”. In step S04 of FIG. 6, a search model is made through assigning priorities in this manner.

The route search section 460 thereafter searches return current routes on the search model made by the model making section 450 (step S05). In examining whether or not a return current route is appropriate, it is not necessary for the designer to know the current distribution of the return current. The designer can examine propriety only by identifying a route as a line through which the largest amount of current flows. In this route search section 460, therefore, a route search to which an automatic wiring route search algorithm heretofore known is applied is made. In a case where wiring routes are automatically searched, a region where no wiring exists is searched as a wiring route search region and intersection and superposition of wiring routes are prohibited. In a case where a return current route search is made, however, the search is made in a power supply GND net having components such as power supply patterns, GND patterns, VIAs and capacitors and intersection and superposition of return current routes with respect to different signals transmitted are permitted. In an automatic searching for wiring routes, a numeric value “cost” is assigned to each portion in a search region and a route is searched for such that the total cost is minimized. In the return current route search, the priority described above is used instead of the cost to enable a search for a route with accuracy. Since the automatic search algorithm applied to the return current route search is originally an algorithm capable of high-speed searching, the return current route search made by the route search section 460 is completed in a short time.

Making of a search model by the model making section 450 and a return current route search made by the route search section 460 are executed with respect to all routes for signal transmission performed on the signal wiring net on the circuit expressed by the CAD data (step S06; N). After the completion of searching for all the return current routes (step S06; Y), data on the routes obtained by searching is sent to the loop size determination section 470 and to the concentration determination section 480. The return current route data is also sent to the display section 420 in the circuit design function section 400a. The display section 420 prepares display data for display of the return current routes on the basis of the CAD data of the circuit designed in the design section 410 and the return current route data sent to the display section 420 (step S07).

The loop size determination section 470 obtains a size of a loop formed by the signal transmission route on the circuit and a return current route obtained with respect to the signal transmission route, and determines whether or not the return current route is suitable. The loop size determination section 470 computes the area surrounded by the loop as an index indicating the size of the loop (step S08), and determines an unsuitable return current route on the basis of the area and the determination condition read by the priority read section 440 described above (the upper limit value of the area for suitability of a route) (step S09).

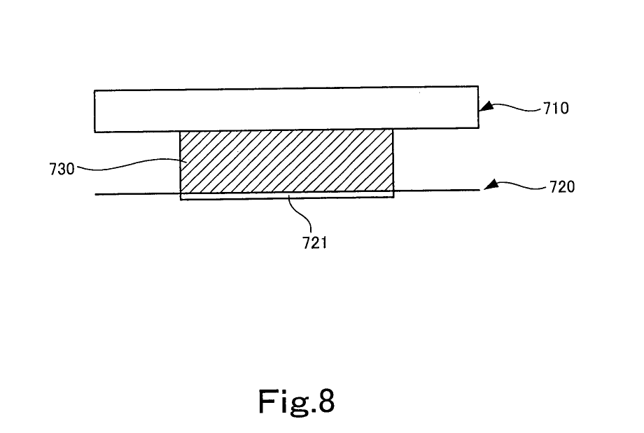

FIG. 8 is a schematic diagram showing the area of a loop.

A power supply layer 710 and a signal layer 720 are illustrated as portions of the circuit in FIG. 8. It is assumed that a return current passes right above a signal wiring conductor 721 when passing through the power supply layer 710. The loop formed by the signal transmission route and the return current route surrounds a region 730 indicated by hatching in FIG. 8. Needless to say, the area of the region 730 thus defined is increased if the signal transmission route and the return current route are distanced from each other. Also, it is apparent that the area of the region 730 is a suitable index of the loop size.

After making determination on the basis of the area in step S09 of FIG. 6, the loop size determination section 470 obtains the difference between the lengths of the signal transmission route and the return current route as another index of the loop size (step S10), and determines an unsuitable return current route on the basis of the obtained difference and the determination condition read by the priority read section 440 described above (the upper limit value of the difference for suitability of a route) (step S11).

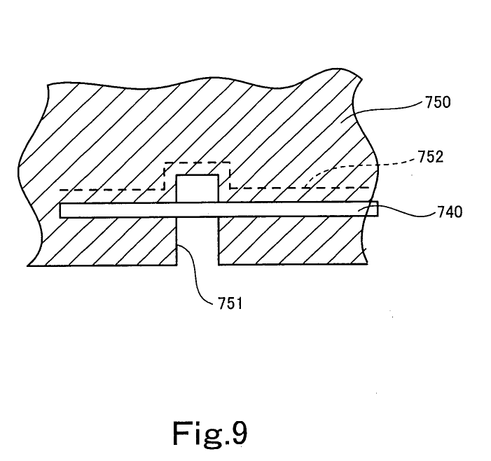

FIG. 9 is a schematic diagram showing the relationship between the loop size and the difference between the lengths of routes.

A signal wiring conductor 740 and a power supply pattern 750 are shown as portions of the circuit in FIG. 9. A slit 751 exists in a portion of the power supply pattern 750. Slits typified by such a slit 751 are frequently formed due to various reasons in terms of wiring layout. If such a slit 751 exists, a return current route 752 cannot extend right below the signal wiring conductor 740 and forms a detour around the slit 751, as illustrated. In this case, the loop size is increased by the detour around the slit 751. Therefore the difference between the lengths of the signal transmission route and the return current route is suitable as an index of the amount of detouring. This index is rather an indirect index but has the advantage of being easily computed.

After determinations have been made by the loop size determination section 470 on the basis of the loop area and the route difference in steps S08 to S11 of FIG. 6 as described above, the determination results are sent to the display section 420 in the circuit design function section 400a.

On the other hand, the concentration determination section 480 searches for a place where return currents are concentrated by counting overlaps between the return current routes with respect to each portion on the circuit (step S12), and determines a concentration portion where there is a problem on the basis of the counted number of overlaps and the determination condition (the upper limit of the number of overlaps) read by the priority read section 440 described above (step S13). The results of this determination made by the concentration determination section 480 are also sent to the display section 420 in the circuit design function section 400a.

The display section 420 displays the return current routes and determination results on the CRT display 102 shown in FIG. 1 on the basis of the display data prepared in step S07 and the determination results sent from the loop size determination section 470 and the concentration determination section 480.

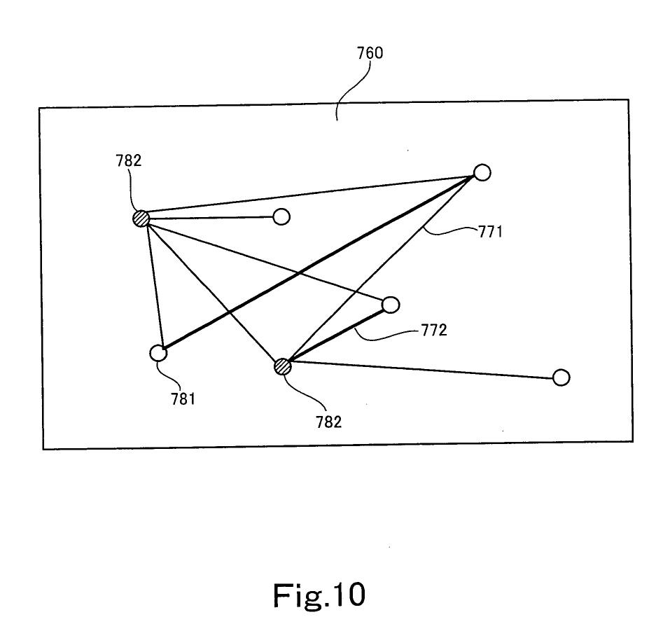

FIG. 10 is a diagram showing an example of a display produced by the display section.

In FIG. 10, a power supply pattern 760 is shown as a portion of the circuit. Seven VIAs 781, 782 are connected to the power supply pattern 760. Also, nine return current routes 771, 772 are indicated by line. Of these nine return current routes 771, 772, the return current routes 772 determined as unsuitable by the loop size determination section 470 are indicated by thicker lines to warn the designer that they are unsuitable. Of the seven VIAs 781 and 782, the VIAs 782 determined as concentration portions where there is a problem by the concentration determination section 480 are displayed in a noticeable color to warn the designer that there is a problem with them. The designer can determine the quality of the circuit design in a comprehensive manner by confirming return current routes and warnings through such a display, and can take necessary steps.

In the description above, an embodiment of the return route search device and the return route search program of the invention is an example in which the return route search device and the return route search program are incorporated in the circuit design apparatus and the circuit design program of the invention. However, needless to say, the return route search device and the return route search program may be a device and a program independent of the circuit design apparatus and the circuit design program of the invention.

In the description above, an example of the starting point/destination point setting section and the easiness setting section has been described as an example of the setting reflection section in accordance with the invention in which a starring point, a destination point and a degree of easiness of conduction are automatically set. However, the starting point/destination point setting section and the easiness setting section may be one in which a starting point, a destination point and a degree of easiness of conduction are set by an operation performed by a designer for example.

While an example of the provision of all the functions corresponding to the first good/no-good determination section, the second good/no-good determination section and the concentration position search section in accordance with the invention has been described, the return route search device and the circuit design apparatus of the invention may be provided with only a part of the first good/no-good determination section, the second good/no-good determination section and the concentration position search section. Alternatively, none of these sections may be provided or all of the determinations may be made by an operator such as a designer.

In the embodiment of the invention described above, a magneto-optical disk for optical recording is used as an example of the information storage medium in accordance with the invention. The information storage medium in accordance with the invention, however, may be any of magneto-optical disks for use in various recording systems such as a magneto-optical recording system, a phase change recording system and a magnetic recording system, any of other disk storage mediums such as optical disks and magnetic disks, a card-type storage medium, or a tape-type storage medium.

What is claimed is:

1. A return route search device comprising:
a starting point/destination point setting section that accepts a setting of a starting point on a circuit from which a return current starts accompanied by a signal transmission on the circuit, and a setting of a destination point on the circuit which the return current reaches;
an easiness setting section that accepts a setting of easiness of conduction of the return current through each of portions on the circuit; and
a return route search section that searches for a route when the return current flows from the starting point to the destination point on the basis of the easiness of conduction on the circuit.

2. The return route search device according to claim 1, further comprising a display section that displays the route obtained by the return route search section.

3. The return route search device according to claim 1, further comprising:
a transmission route identification section that accepts identification of a route of the signal transmission on the circuit; and
a setting reflection section that sets the starting point and the destination point in the starting point/destination point setting section on the basis of the route identified in the transmission route identification section and a predetermined setting rule, and that sets the easiness of conduction in the easiness setting section.

4. The return route search device according to claim 1,
further comprising:
a transmission route identification section that accepts identification of a route of the signal transmission on the circuit; and
a first good-bad determination section that computes the area surrounded by a loop going through both the route identified in the transmission route identification section and the route obtained by the return route search section, and that determines whether or not the return current route is good on the basis of the area.

5. The return route search device according to claim 1,
further comprising:
a transmission route identification section that accepts identification of a route of the signal transmission on the circuit; and
a second good-bad determination section that computes the difference between the length of the route identified in the transmission route identification section and the length of the route obtained by the return route search section, and that determines whether or not the return current route is good on the basis of the difference.

6. The return route search device according to claim 1, wherein the starting point/destination point setting section accepts the setting of a starting point and the setting of a destination point with respect to each of a plurality of return currents generated with each of a plurality of signal transmissions,
the easiness setting section accepts the setting of easiness of conduction in correspondence with each of the plurality of signal transmissions,
the return route search section searches for a plurality of routes corresponding to each of the plurality of return currents, and
the return route search device further comprises a concentration position search section that obtains a position at which the plurality of routes are concentrated on the circuit.

7. A circuit design apparatus comprising:
a design section that designs a circuit in accordance with an operation;
a starting point/destination point setting section that accepts a setting of a starting point on the circuit designed in the design section, from the starting point starting a return current generated with a signal transmission on the circuit, and a setting of a destination point on the circuit which the return current reaches;
an easiness setting section that accepts a setting of easiness of conduction of the return current through each of portions on the circuit designed in the design section; and
a return route search section that searches for a route when the return current flows from the starting point to the destination point on the basis of the easiness of conduction on the circuit.

8. A circuit design program storage medium storing a circuit design program that is incorporated in a computer and constructs on the computer:
a design section that designs a circuit in accordance with an operation;
a starting point/destination point setting section that accepts a setting of a starting point on the circuit designed in the design section, from the starting point starting a return current generated with a signal transmission on the circuit, and a setting of a destination point on the circuit which the return current reaches;
an easiness setting section that accepts a setting of easiness of conduction of the return current through each of portions on the circuit designed in the design section; and
a return route search section that searches for a route when the return current flows from the starting point to the destination point on the basis of the easiness of conduction on the circuit.
